(19) United States
(12) Patent Application Publication
(10) Pub. No.: US 2008/0166211 A1
(43) Pub. Date: Jul. 10, 2008

(54) Inline terminal, Hub and Distribution System

(75) Inventors: John J. Lanigan, Orland Park, IL (US); Peter W. Mirabella, Schererville, IN (US)

Correspondence Address: Gary J. Cunningham, 620 Courtland Circle, Western Springs, IL, 60558, US

(73) Assignee: MIJACK PRODUCTS, INC., Hazel Crest, IL (US)

(21) Appl. No.: 11/650,772

(22) Filed: Jan. 9, 2007

(51) Int. Cl. B65G 67/02

(52) U.S. Cl. 414/341

(57) ABSTRACT

The present invention provides an inline terminal, hub and distribution system (200). It comprises the steps of; transporting (202) a first container with a cargo via an inbound railroad car to a terminal having a plurality of train rails; carrying (204) the first container from the railroad car to a track side location in proximity to the plurality of train rails; moving (206) the first container via a tractor truck to an inbound dock of a distribution warehouse; emptying (208) at least some of the cargo in proximity to the inbound dock in the distribution warehouse for sorting; loading (210) a second container located at an outbound dock of the distribution warehouse; trucking (212) the second container from the outbound dock via the first or a second tractor trailer to a desired location.

### FIELD OF THE INVENTION

This invention relates to transportation and logistics systems, and more particularly to an Inline Terminal, Hub and Distribution system.

### BACKGROUND OF THE INVENTION

Freight transport continues to grow at a rapid pace, especially in the heavy-rail sector. Severe bottlenecks are seen in existing rail transfer terminals, which result in freight delays. Most such terminals have little or no right-of-way available for terminal expansion. Inefficiencies associated with moving containers from terminal to terminal by truck, to transfer between long-distance rail carriers (corridors), introduce significant delays, costs and inefficiencies. Further, truck activity on urban and suburban freeways cause increased fuel consumption and pollution emissions.

In connection with transportation logistics, market forces are driving the development of new technologies to improve the efficiency of freight transfer operations at rail terminals. A rail ThruPort, which is analogous to an airports, refers to a rail facility where Class I railroads will be able to dock and exchange freight with a high degree of automation. This transfer method can increase freight transfer efficiency. Additionally, ThruPorts can help to significantly reduce on road truck traffic associated with the current practice of moving containers, typically across town, from terminal to terminal, to make a corridor transfer from the east to the west, for example. As used herein, ThruPort refers to an efficient operational solution in connection with a rail facility, whereby an overhead crane can be used to shuffle containers from train to train in a single step.

In connection with transportation logistics, there is a need for the development of new technologies to improve the efficiency of freight transfer operations at rail terminals.

### BRIEF DESCRIPTION OF THE DRAWINGS

FIG. 1 is a flow diagram of an Inline Terminal, Hub and Distribution System, in accordance with the instant invention.

FIG. 2 is a plan view of the Inline Terminal, Hub and Distribution System, in accordance with the instant invention.

FIG. 3 is an elevation view of the Inline Terminal, Hub and Distribution System in FIG. 2, in accordance with the instant invention.

FIG. 4 is a portion of a plan view of a second embodiment of the Inline Terminal, Hub and Distribution System, in accordance with the instant invention.

FIG. 5 is the other portion of a plan view of the second embodiment of the Inline Terminal, Hub and Distribution System shown in FIG. 4, in accordance with the instant invention.

FIG. 6 is a plan view of a third embodiment of the Inline Terminal, Hub and Distribution System, in accordance with the instant invention.

FIG. 7 is a flow diagram of an Inline Terminal, Hub and Distribution System, in accordance with the instant invention.

### DESCRIPTION OF A PREFERRED EMBODIMENT

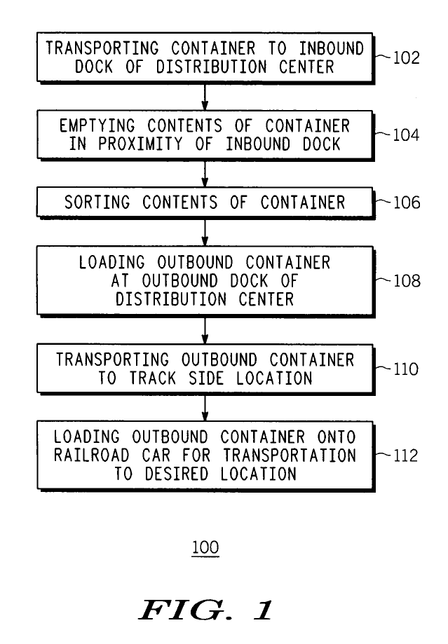

In its simplest form, an Inline Terminal, Hub and Distribution system and process flow diagram 100 is shown (hereafter referred to interchangeably as Inline Terminal, Inline System and/or Hub and Distribution System). Referring to FIG. 1, the system comprises the steps of: transporting 102 (hereafter the transporting or first transporting step 102) a container to an inbound dock of a distribution center; emptying 104 (emptying step 104) the contents of the container in proximity to the inbound dock; sorting 106 (sorting step 106) the contents of the container; loading 108 (loading step 108) an outbound container at an outbound dock of the distribution center; transporting 110 (transporting or second transporting step 110) the outbound container to a track side location; loading 112 (loading or second loading step 112) the outbound container onto a railroad car for transportation to a desired location. The system provides improved utilization of the available space and improved efficiency for loading and unloading of trains resulting in substantial savings in distribution and handling costs, in turn enabling rail and trucking transportation costs to be more cost competitive.

The term “container” as used herein has its common ordinary meaning, and can include any type of container, such as an ISO container, domestic container, semi-trailer, enclosure, trailer and the like, as understood by those skilled in the art. In a preferred embodiment, ISO and domestic containers with conventional corner castings work well in this system.

The terms “tractor, truck and tractor trailer” have their generally accepted meanings and are generally used interchangeably. These vehicles are used to pull, carry and/or haul containers.

The “Strip Mall” design, concept and layout provides an efficient design layout, whereby all the necessary buildings, storage, roadways, traffic flows, track placements, offices, parking and the like, are strategically placed for simplified operations and minimal unnecessary movement of containers, while striking a balance with the available real estate, as should be understood by those skilled in the art. The terminal can be owned, for example, by one entity or a number of different entities, to minimize or share operational costs and maximize efficient transportation logistics, as will be more fully appreciated from a review of the drawings and the description in this application.

The Inline Terminal or “Throughport” concept and design provides a seamless flow of cargo that requires less real estate and storage area for storing trailers and containers. An important factor relative to the Inline Terminal is that it can help to reduce handling of cargo. The Inline Terminal design is flexible in that the trackside operation can be changed in a matter of minutes to accommodate new requirements or unforeseen events (trackside ramp operations unloading and loading in and outbound trains with cargo which are stored in containers and trailers), for example.

The Inline Terminal concept also includes an integrated distribution hub center with a strip-mall configuration located on a rail intermodel property directly adjacent to a ramp operation for receiving or shipping cargo by rail in lieu of truck trailers. It also accommodates truck line carriers located on the rail premises for the purpose of utilizing the rail shipment of freight in trailers in lieu of using the highway, which will reduce the truck line operating costs, congestion on the highway, fuel consumption and poisonous gases into the atmosphere.

The Inline Terminal or through port lay out can operate all necessary functions inline (parallel to the tracks), and controls most necessary functions under an overhead crane for its operation, for inbound and outbound cargo, including temporary storage of containers at 142 with cargo, under the crane. A “strip mall” is adjacent and substantially parallel with the inline ramp operation and is typically substantially rectangular, or can be approximately 1200 ft wide by 800 ft to 2 miles long depending on anticipated volume of traffic, and is designed to be adaptable and flexible enough to expand the operating procedures depending on the anticipated volume.

The Inline Terminal design can include 15 to 20 tracks under an overhead crane with typically one or two grapplers to load and unload cargo from the tracks beneath the crane. Some of the tracks can be dedicated to certain railroad lines, such as Santa Fee, Union Pacific, Conrail, Norfolk and CSX, for example. Thus, various concourses such as tracks a and b, could be concourse one, tracks c and d could correspond to concourse two, tracks e and f could be concourse three and so forth, and in turn each concourse could relate to an individual railroad line and/or corridor. As will be appreciated, a grappler can simply pick up one to three containers from a rail car on one track (on an east corridor) and move them to a different rail car on a different track (on a different corridor, say a south corridor), on rail cars owned by the same or different railroad lines.

The terminal manager has the ability to accommodate any change in his operating volume by changing the design of the ramp operation to any trackside configuration whenever it is deemed necessary to maintain the desired flow of cargo in a matter of minutes. Changing the ramp trackside operation can be done any time of day in the event of the following:
Derailment on the main line
Equipment down (not operating)
Late inbound or outbound trains, relating to arrival and departure
Customer not picking up trailer or container within 24 hours causing undesirable congestion (terminal manager can use storage under crane without interfering with normal operation)
Late arrival of high volume customers (40 trailers or more), customers notify terminal manager that freight will be up to 3 hrs late, terminal manager can pre-block rail cars prior to freight arriving
Mainline down or derailed, all inbound rail traffic will be late until main line is operating, all traffic will be blocked to enter terminal, however, with the inline terminal design, all traffic can be directed under crane when each train arrives
All outbound cargo can be accommodated as soon as each railroad car is unloaded
Distributor hubs can ship direct to its final destination without interchange
Shortage of rail cars at trackside can now be pre-blocked, trailers or containers can be ready to load at trackside when railroad cars arrive at terminal
Extra rail cars can be shipped or stored under crane
Rail interchange can be transferred from one corridor to another under the crane in a matter of minutes instead of days
No chassis required
Movement of containers or trailers to a remote storage area is not required.

The terminal manager has a multiplicity of different operations to select from, depending on the circumstances, whether it be a late arrival, outbound, an unexpected influx of cargo volume, derailment, etc. Also, the terminal manager can setup his ramp operations to a two to one, four to one, or six or eight to one track layout unloading on one side of the track leaving the unloaded trailers or containers ready for pickup at trackside and loading outbound trailers or containers on other side of the tracks.

The total requirement for real estate including all roadways, storage area, gate entry and exits, strip malls and ramp operations can vary widely, and typically can be from 800 ft long to 2 miles long and 1200 ft wide depending on volume. The Inline System can be designed with a 1200 ft wide configuration to encourage other railroad carriers who are required to transfer interchange to another corridor other than their own and now can be located as neighbors adjacent to one another to simplify interchange and the flow of traffic and still be able to operate independently from the other carriers that are all within a close proximity on the same real estate plot of land.

Conventional known terminals that are in existence today do no have any or all of the outlined advantages described herein.

The first transporting step 102, can include: entering a hub and distribution center comprising a substantially contiguous site including a plurality of train rails and a distribution warehouse in proximity to the train rails; and checking in to obtain instructions, directions, permissions, the rules of the facility and the like.

In more detail, the transporting step 102 can include: providing at least one inbound dock and at least one outbound dock on a same side or different side of the distribution warehouse; and allowing the inbound and outbound docks to be used interchangeably.

In a preferred embodiment, the terminal includes entering a terminal with a substantially centrally located entrance for the truck operator, to provide a logical, required and intuitive traffic flow in the terminal. Advantageously, this provides for ease of movement, simplicity in traffic flow and monitoring, and an intuitive roadway (simplified logistics), to allow such truck operators to check in, if needed, and enter and exit in the most efficient manner possible.

The sorting step 106 can include at least one of: moving at least some of the container contents (or cargo) to temporary storage for later loading; and loading at least some of the contents into an outbound container.

In a preferred embodiment, the sorting step 106 includes: inspecting the contents to confirm that it is not damaged; inventorying the inbound container; and documenting the results of the inspecting and inventorying steps.

In a preferred embodiment, the second transporting step 110 includes positioning and aligning the outbound container in a substantially parallel orientation with respect to and adjacent to the rail tracks by using a tractor trailer.

In more detail, the second loading step 112 can include: lifting a container in a substantially vertical and horizontal direction; transporting the container in a substantially perpendicular direction with respect to the rail tracks; and lowering the container in a substantially vertical direction onto a railroad car, in a substantially unitary step by use of a crane.

In one embodiment, the crane includes a straddle lift type crane, for example, a Translift type crane, available from MiJack Products, Inc. in Hazel Crest, Ill., for improved efficiency in loading and unloading operations.

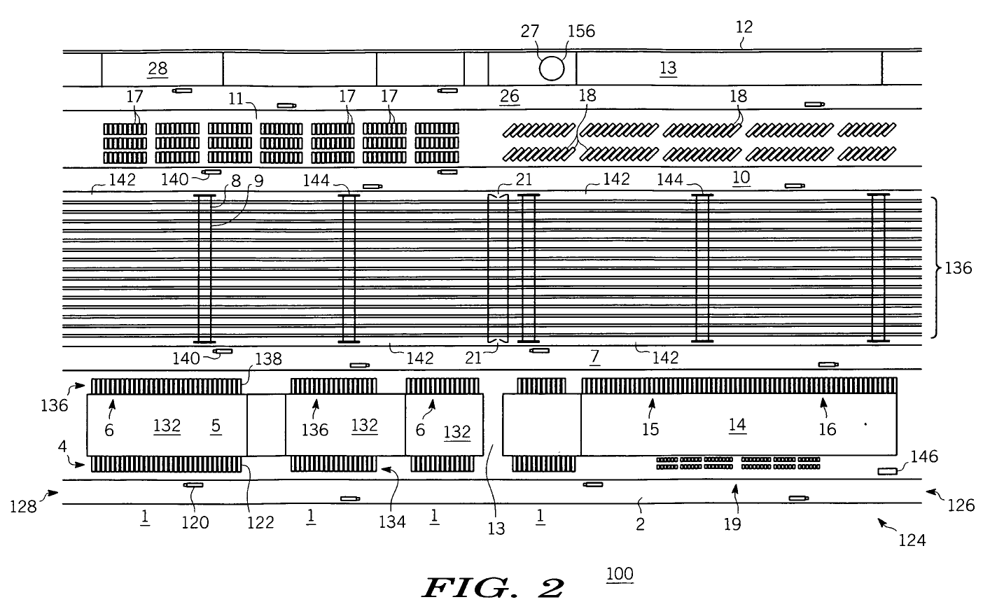

FIG. 2 is a plan view of the inline terminal, hub and distribution system 100. In more detail, a preferred hub and distribution system 100 (from ground to rail), includes: a tractor truck 120 for transporting an inbound container 122; a hub and distribution center 124 being a substantially contiguous plot of land having an entrance 126 and an exit 128, including a plurality of train rails 130 and a distribution warehouse 132 in proximity to the train rails 130; the distribution warehouse 132 including an inbound dock 134 for emptying and sorting the cargo of the inbound container 122 in proximity to the inbound dock 134 and an outbound dock 136, wherein at least some of the cargo is moved to temporary storage facilities and at least some is moved into an outbound container 138; a second tractor truck 140 for transporting the outbound containers 38 to a track side locations 42, preferably immediately adjacent and parallel to the train rails; and a crane 144 for loading the outbound container 138 onto a railroad car 146 for transportation to a desired location.

The inline terminal, hub and distribution center 124 includes a check in office 148 for providing at least one or more of instructions, directions, permissions and rules to truck drivers and operators for improved efficiency.

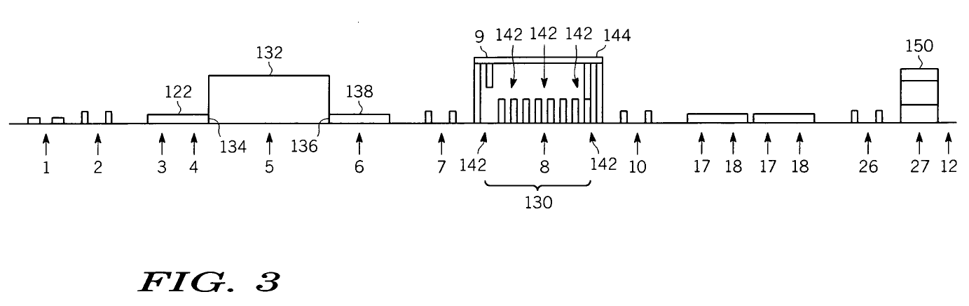

The track side location 142, as shown in FIG. 3, provides a temporary storage location, for an inbound or outbound container 122 and 138, for more efficient operations.

In a preferred embodiment, the distribution warehouse 132 includes means for sorting the cargo of the inbound container, manually or automatically with a fork lift, for example, including at least one of: means for inspecting the cargo, visually, by use of cameras, and the like; means for inventorying the inbound container, with bare code scanning, RF identification and the like; and means for documenting the results of the inspection and inventory, by means of a computing or the like device.

The first and second tractor trucks are the same or different tractor trucks with the same or different operators.

In a preferred application, the crane includes a straddle lift crane and the hub and distribution center comprises a generally long and narrow plot of land for improved utilization of the available space and improved efficiency for loading and unloading of trains.

In one embodiment, the inline terminal, hub and distribution system provides a high density and narrow-profile continuous plot (or substantially contiguous site) of land substantially adjacent and parallel to railroad tracks. The system provides improved utilization of the available space and improved efficiency for loading and unloading of trains.

The inline terminal, hub and distribution center can be a secure area, which can be enclosed with a fence and have at least one or more security gates.

The docks are constructed to provide a structure to facilitate loading and unloading of containers.

The inline terminal, hub and distribution center is designed to allow all personnel, that is, the control station and check in personnel, truck operators, crane operators, engineers, loaders, devaning (unloading) personnel and the like to work together as a team, to provide an efficient team effort and process. It is desirable to have a smooth, steady and efficient flow of trains and tractor tractors in and out of the facility.

Additionally, operators and security personnel are able to communicate with each other, using cellphones, transceivers, and the like for improved efficiencies of the operations. Thus, the various operators can communicate and/or control various equipment via land lines or wirelessly, as appropriate.

In a preferred embodiment, outdoor storage facilities for containers, positioned near the tracks are used, for improved space utilization of the available real estate.

In a preferred embodiment, straddle lift type cranes, known as Translifts, provide an efficient and unitary means of moving, picking and placing the containers on and off railcars, tractor trailers and the like.

It is contemplated, for example, that the unloading step can include a “just-in-time” option, comprising unloading a first container directly from the train car to a tractor trailer or vice versa (rail or street inbound), free of a storage step. This could be desirable if a container is needed right away and thus allows for expedited unloading.

The inline terminal, hub and distribution center can include storage areas on opposite sides of the track, for improved space utilization.

As illustrated in FIGS. 2-5, unloading can include unloading more than one container from the train car substantially simultaneously or at the same time, for improved efficiency.

As shown in the figures, several cranes can be used to load and unload in this operation. For example, Translift cranes typically have two grapplers on a single crane. Ine grappler picks up a container out of a double stack railcar and creates an empty double stack car for the second grappler to deposit two containers for interchange on the same double stack car. Stated another way, one grappler creates an empty double stack car and the other deposits one or more containers on the same car. In a preferred embodiment, using two grapplers on a single crane, is a highly efficient method of interchange. For example, if containers on a west corridor (tracks) must be transferred to an east corridor (different tracks), or vice versa, two grapplers working in harmony can significantly simplify and reduce the interchange cycle time.

As should be appreciated by those skilled in the art, having a plurality of cranes working in harmony, can provide a more efficient operation and reduces cycle time.

In the embodiment shown in FIGS. 2 and 3, a “strip mall” type warehouse hub and distribution center is shown, which is integrated into the overall inline system. In a preferred embodiment, it typically includes the following:
1. Employee parking
2. A four lane road to accommodate deliveries for inbound freight from rail to exit streets or from the street to rail.
3. A parking area for inbound freight or containers from the street delivered to inbound receiving doors or loading docks.
4. Inbound trailers or containers are parked at loading docks or overhead doors.
5. Warehouse hub distribution center, which can vary widely, such as from 50,000 to 500,000 square feet, for example.
6. Outbound trailers ready to be shipped by rail intermodal to be loaded on its designated corridor and shipped to its final destination area without an interchange
7. Four-lane road to accommodate inbound and outbound freight to and from the warehouse.
8. Straddle type crane with multiple grapplers are designed to load and unload trailers and containers for intermodal ramp operation.
9. Stackpack overhead type crane 250 feet wide, equipped with two grapplers straddling fifteen tracks including six corridors. All tracks under the overhead Stackpacker crane are numbered on the top beam, equipped with red flashing lights indicating on which track the blue flag is removed.
10. Four-lane road to accommodate overhead ramp operation for loading and unloading trailers and containers.
11. Storage area for empty chassis and trailers.
12. Run around track or balloon track that operates the circumference of the terminal.
13. Run through lane for inbound freight approximately every six hundred feet.
14. Two hundred thousand square foot warehouse hub center with receiving and shipping facing rail intermodal, which is an optional design.
15. Outbound trailers
16. Inbound trailers
17. Empty chassis
18. Empty trailer
19. Employee's parking in rear of warehouse.
20. Blue flag controllable by the tower's rail line controller. When the blue flag is removed, red lights go on flashing and crossover gates automatically come down. The bell rings and the redlight flashes.
21. Crossover gate
22. Optional crossover by disconnecting all purpose rail cars by approximately thirty feet.
23. If and when this crossover is utilized, there will be a crossover automatic gate that will come down when the blue flag is removed.
24. Warehouse employees are typically provided keyless entry to enter and exit the terminal.
25. All truck drivers and locomotive engineers will typically switch to the towers frequency when entering and exiting the terminal.
26. Roadway
27. Operator tower typically forty by forty by fifty feet high.
28. Temporary trailer freight storage area.

Notes for embodiment shown in FIGS. 2 and 3:

Fifteen train rails are configured under the overhead crane. It has the capability of providing six dedicated corridors for all class 1 railroads, two for one design for intermodal ramp operation.

All track centers are sixteen feet wide, with a paved ground level to track. Advantageously, at sixteen feet centers, it allows enough room between rail cars to drive a Grunt (small pick up like-truck, with a high platform), to remove or install IBCs (interbox connectors). The platform is at a predetermined level, to allow a person to be at the correct level or height of a corner casting of a container, to install or remove IBCs easily.

A terminal manager has the capability to configure the ramp operation depending on the volume at the terminal.

This terminal layout illustrates the purpose of accommodating truck line carriers and warehouse hub centers, similar to single company centers, such as Walmart, who market general merchandise and who have their hub centers located on rail premises.

The amount of warehousing and layout depends on the available real estate and needs or application.

The numbers above the crane illustrate the track number. Above each number on the crane there is a light which indicates the status of the blue flag, in a preferred embodiment.

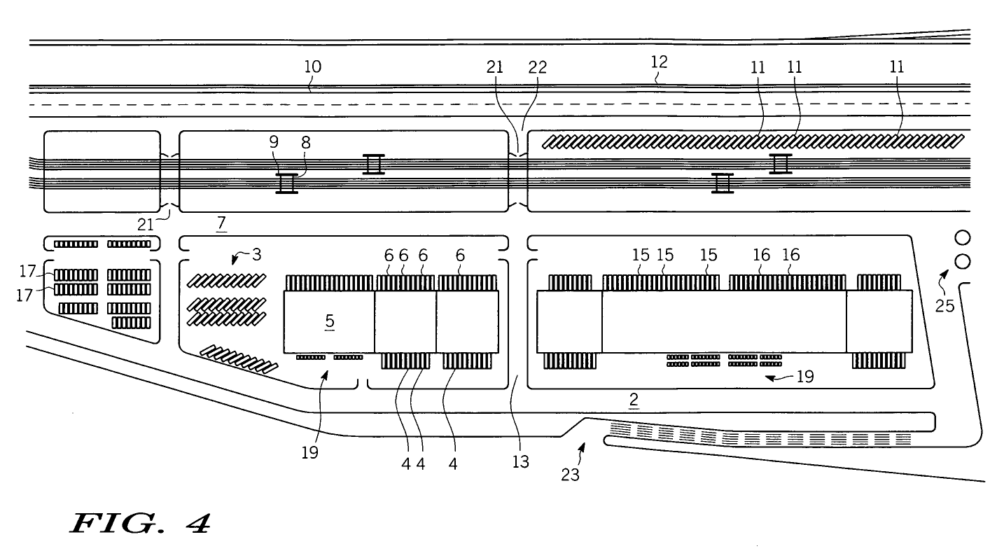

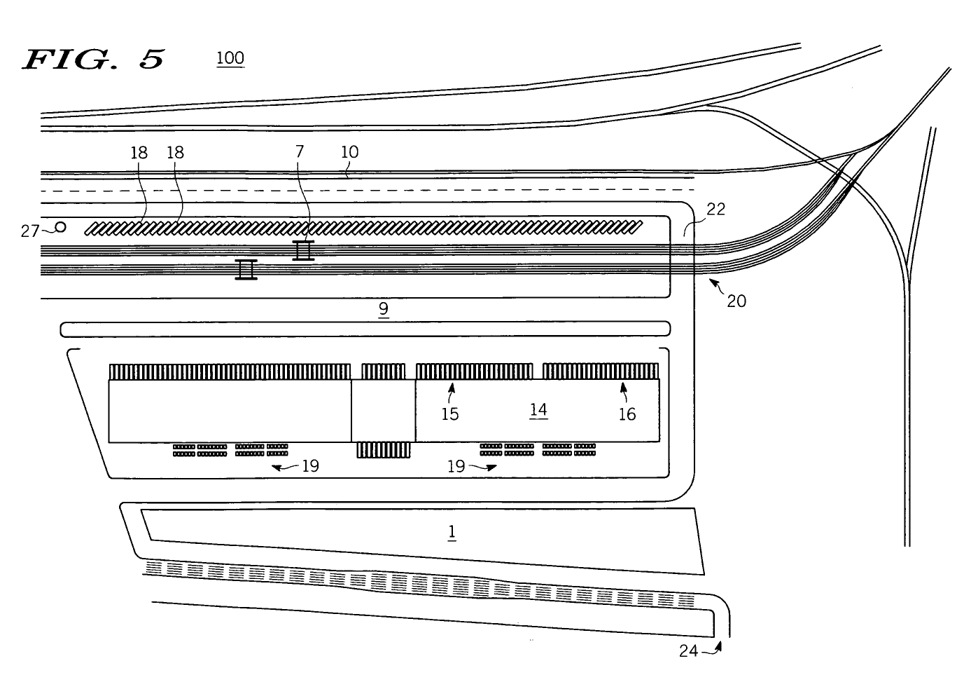

Detailed below is an intermodal facility feature identification chart, for the inline terminal, hub and distribution center embodiment shown in FIGS. 4 and 5.
1. Facility service area and employees parking
2. Four-lane road to accommodate deliveries for inbound freight from rail and exit streets.
3. Parking area for inbound freight delivered to inbound receiving overhead doors.
4. Inbound trailers parked at overhead receiving doors for unloading.
5. Warehouse hub distribution center, typically fifty thousand to five hundred thousand square feet.
6. Outbound trailers ready to ship by rail intermodal to be loaded on the desired or designated corridor and shipped direct to final designation, preferably without the need for an additional interchange.
7. Four-lane road to accommodate inbound and outbound freight to and from the warehouse hub center.
8. Specially designed grappler to load and unload trailers and containers for intermodal ramp operation.
9. Overhead crane equipped with two grapplers straddling five tracks.
10. Four-lane road to accommodate overhead ramp operation for loading and unloading trailers and containers.
11. Storage area for empty chassis and trailers.
12. Run around track or balloon track provided around the circumference of the terminal.
13. Run through lane for inbound freight.
14. Two hundred thousand square foot warehouse hub center with receiving and shipping facing rail intermodal area, is shown in this embodiment.
15. Outbound trailers
16. Inbound trailers
17. Empty chassis
18. Empty trailer
19. Employee parking in rear of warehouse.
20. Blue flag can be controlled by the tower's rail line controller.
When the blue flag is removed, red lights flash and the crossover gates automatically close or are lowered. The bell rings and the red light flashes.
21. Rail crossover gate 22. Rail crossing for inbound and outbound trailers and containers.
23. Entrance to intermodal facility to Summit Street.
24. Exit from intermodal facility to Summit Street.
25. Under-pass for trailer and container traffic.
26. Pier designation
27. Control tower

Detailed below are additional notes regarding the embodiment shown in FIGS. 4 and 5.

Cranes do not run under the bridge, but do operate on either side of the bridge. This note is provided in one design to be thorough in the drawings. The terminal is located below an expressway, and the bridge has little relevance to the instant invention.

Warehousing, number of tracks and cranes are shown for illustration purposes only. As should be understood by those skilled in the art, size, location and quantity may vary widely depending on the available real estate, budget, application, etc.

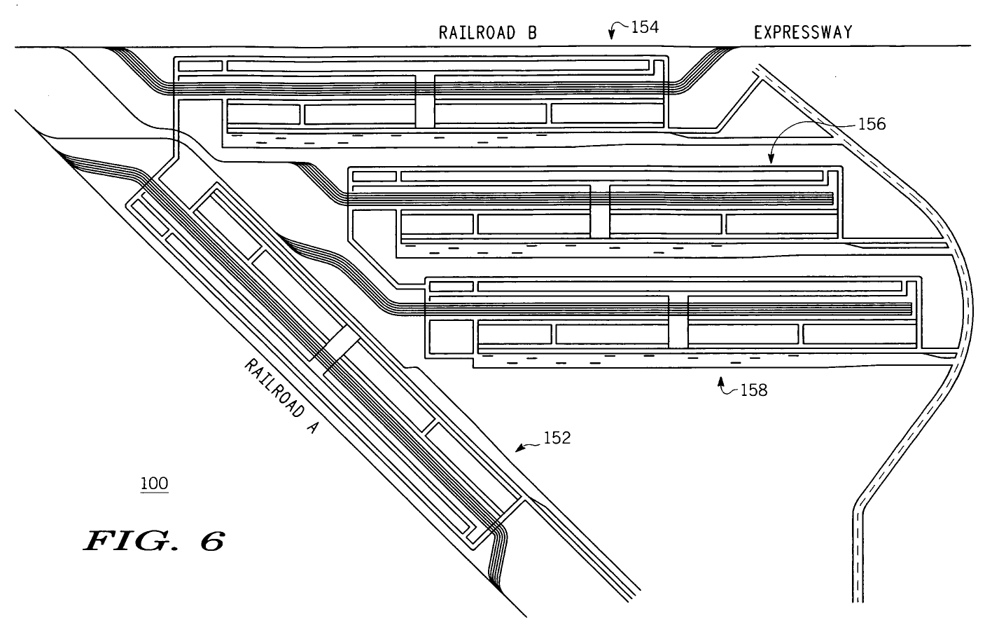

FIG. 6 is a plan view of a third embodiment of the Inline Terminal, Hub and Distribution System, in accordance with the instant invention. In more detail, the system 100 includes separate individual hub and distribution systems 152, 154, 156 and 158. Each has some or all of the structure and process steps previously discussed, with respect to the other embodiments. Each system has a central roadway for entering each in a substantially central location, for improved traffic flows and traffic logistics, as discussed earlier in more detail. Again, this embodiment is strategically designed and configured with various competing constraints in mind, such as each system's individual requirements, budget and available real estate.

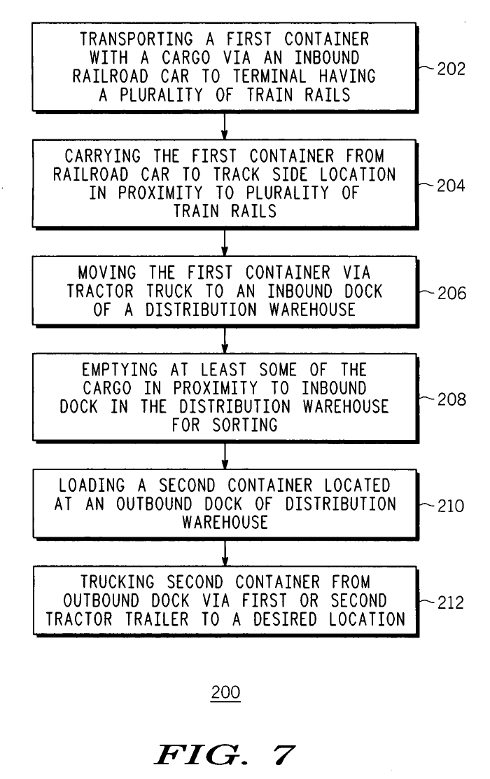

Referring to FIG. 7 and the previous figures, another embodiment of the an inline terminal, hub and distribution system 200 is shown. In it's simplest form, it comprises the steps of: transporting 202 a first container with a cargo via an inbound railroad car to a terminal having a plurality of train rails; carrying 204 the first container from the railroad car to a track side location in proximity to the plurality of train rails; moving 206 the first container via a tractor truck to an inbound dock of a distribution warehouse; emptying 208 at least some of the cargo in proximity to the inbound dock in the distribution warehouse for sorting; loading 210 a second container located at an outbound dock of the distribution warehouse; trucking 212 the second container from the outbound dock via the first or a second tractor trailer to a desired location. The system provides enhanced efficiency and logistics over the known art.

In a preferred embodiment, the trucking step 212 includes the second tractor trailer, entering the terminal at a substantially central location; providing a substantially contiguous site including a plurality of train rails and at least one distribution warehouse in proximity to the train rails, defining a strip mall complex; and the second tractor trailer, checking in to obtain pick up instructions and directions. This helps to provide a directed work and traffic flow in and around the terminal.

As should be understood by those skilled in the art, the inbound dock and the outbound dock can be on a same side or different sides of the distribution warehouse, and such docks can be used interchangeably. Typically, there are several docks to allow for multiple loadings and unloadings of containers, distributing and sortings of cargo and the like, substantially simultaneously, for improved efficiencies in scale.

Likewise, the emptying step 208 can include sorting and distributing the cargo in the warehouse, moving at least some of the cargo from the first container to temporary storage in the distribution warehouse for later loading; and loading at least some of the cargo into the second container or a different container.

As detailed previously in connection with an earlier embodiment, in a preferred embodiment, the emptying step 208 can include sorting the cargo, which includes: inspecting the cargo to confirm that it is not damaged; inventorying the first container; and documenting the results of the inspecting and inventorying steps. These steps are important so that one can audit the process and eliminate or minimize waste or core problems in connection with logistics, for example.

As discussed with previous embodiments, in a preferred embodiment a strip mall complex is provided, and it includes the terminal, distribution warehouse, offices for security and terminal employees, accessible temporary container storage both indoors and outside, a series of roadways and pathways for pedestrians, maintenance shops and the like and parking, adapted to improve efficiency in transporting containers, safety and logistics of working personnel.

In a preferred embodiment, the carrying step 204 can include: lifting a container from the railroad car in a substantially vertical direction; transporting the container in a substantially perpendicular direction with respect to the rail tracks; and lowering the container in a substantially vertical direction onto the track side location, in a substantially unitary movement by use of a crane. A straddle lift crane is particularly adapted to perform this step efficiently.

As shown in FIG. 6, a plurality of terminals 152, 154, 156 and 158 are provided, and are shown clustered in general proximity to each other. This embodiment provides for customized and individualized control and distribution of fleets of containers, tractor trailers, cranes and the like. Preferably, each terminal has a strip mall complex for improved efficiencies.

Referring to the figures, in one embodiment, the system 200 includes: a terminal including a substantially contiguous plot of land having a roadway with an entrance 126 and an exit 128, a plurality of train rails 130 and a distribution warehouse 124 in proximity to the train rails 130; the distribution warehouse 124 including an inbound dock for facilitating emptying and distributing of cargo and an outbound dock, wherein the distribution warehouse 124 is adapted to allow ease of movement of cargo between the inbound and outbound docks and provide temporary storage of the cargo; a crane for carrying a container from a railroad car 146 to a track side location 142 or visa versa (discussed previously with respect to an earlier embodiment); and at least one tractor truck 140 for trucking the container from the track side location to or from an inbound or outbound loading dock or visa versa (discussed previously with respect to an earlier embodiment); and the at least one tractor truck 120 for trucking the container from the outbound loading dock to a desired location away from the terminal.

Preferably, the entrance 126 to the terminal includes a roadway strategically positioned to direct the tractor trucks to begin at a substantially centrally located position for defining a desired traffic flow in and around the terminal.

As should be understood by those skilled in the art, the terminal is adapted to accommodate a plurality of cranes, tractor trailers, roadways and movement of containers independently and in an integrated fashion, to provide a steady flow of containers in and out of the terminal. Likewise, the strip mall provides similar advantages to workers, maintenance and office personnel, pedestrians, etc.

As should be understood by those skilled in the art, there are numerous embodiments of the invention shown and described. It should be understood that various modifications and substitutions, as well as rearrangements and combinations of the preceding embodiments, can be made by those skilled in the art without departing from the spirit and scope on the instant invention.

What is claimed is:

1. An inline terminal, hub and distribution system, comprising the steps of:
transporting a first container with a cargo via an inbound railroad car to a terminal having a plurality of train rails;
carrying the first container from the railroad car to a track side location in proximity to the plurality of train rails;
moving the first container via a tractor truck to an inbound dock of a distribution warehouse;
emptying at least some of the cargo in proximity to the inbound dock in the distribution warehouse for sorting;
loading a second container located at an outbound dock of the distribution warehouse;
trucking the second container from the outbound dock via the first or a second tractor trailer to a desired location.

2. The system of claim 1 wherein prior to the trucking step, including at least one step of:
the second tractor trailer, entering the terminal at a substantially central location;
providing a substantially contiguous site including a plurality of train rails and at least one distribution warehouse in proximity to the train rails, defining a strip mall complex; and
the second tractor trailer, checking in to obtain pick up instructions and directions.

3. The system of claim 1 wherein further comprising:
providing at least one inbound dock and at least one outbound dock on a same side or different sides of the distribution warehouse; and
allowing the inbound and outbound docks to be used interchangeably.

4. The system of claim 1 wherein the emptying step includes sorting and distributing the cargo, including at least one of:
moving at least some of the cargo from the first container to temporary storage in the distribution warehouse for later loading; and
loading at least some of the cargo into the second container or a different container.

5. The system of claim 1 wherein the emptying step includes sorting the cargo, including at least one of: inspecting the cargo to confirm that it is not damaged; inventorying the first container; and documenting the results of the inspecting and inventorying steps.

6. The system of claim 1 wherein the carrying step includes positioning the first container in a substantially parallel orientation with respect to and substantially adjacent to the train rails at the track side location and further comprising: providing a strip mall complex comprising the terminal and distribution warehouse and including at least one of offices, temporary container storage, roadways, shops, track rails and parking, adapted to improve efficiency in transporting containers and logistics.

7. The system of claim 1 wherein the carrying step includes:
lifting a container from the railroad car in a substantially vertical direction;
transporting the container in a substantially perpendicular direction with respect to the rail tracks; and
lowering the container in a substantially vertical direction onto the track side location, in a substantially unitary movement by use of a crane.

8. The system of claim 1, further comprising providing a plurality of terminals clustered in general proximity to each other, for customized control and distribution of fleets of containers, tractor trailers and cranes.

9. The system of claim 1, further comprising strategically placing strip mall complexes, each defined by a terminal, warehouse and at least one of offices, temporary container storage facilities, roadways, shops, track rails and automobile parking clustered in substantial proximity to each other along track rail lines.

10. An inline terminal, hub and distribution system, comprising the steps of:
providing a contiguous site including a plurality of train rails and at least one distribution warehouse in proximity to the train rails, defining a terminal;
transporting a first container with a cargo via an inbound railroad car to the terminal;
carrying the first container from the railroad car to a track side location in proximity to the plurality of train rails in a substantially parallel orientation with respect to the train rails;
moving the first container via a tractor truck to an inbound dock of a distribution warehouse;
emptying at least some of the cargo of the first container in proximity to the inbound dock in the distribution warehouse for sorting;
loading a second container located at an outbound dock of the distribution warehouse; and
trucking the second container from the outbound dock via the first or a second tractor trailer to a desired location, the second tractor trailer: entering the terminal at a substantially central location; and checking in to obtain instructions, prior to trucking the second container to the desired location.

11. The system of claim 10, further comprising:
providing a strip mall complex comprising the terminal, distribution warehouse and at least one of offices, temporary container storage, roadways, shops, track rails and parking;
providing at least one inbound dock and at least one outbound dock on a same side or different sides of the distribution warehouse; and
allowing the inbound and outbound docks to be used interchangeably, to improve efficiency in transporting containers and logistics and minimize costs.

12. The system of claim 10 wherein the emptying step includes sorting and distributing the cargo, including at least one of:
moving at least some of the cargo to temporary storage for later distribution; and
loading at least some of the cargo into the second container or a different container.

13. The system of claim 10 wherein the emptying step includes sorting the cargo, including at least one of: inspecting the cargo to confirm that it is not damaged; inventorying the first container; and documenting the results of the inspecting and inventorying steps.

14. The system of claim 10 wherein the carrying step includes:
lifting the first container in a substantially vertical direction from the railroad car;
transporting the first container in a substantially perpendicular direction with respect to the rail tracks; and
lowering the container in a substantially vertical direction onto the track side location, in a substantially unitary movement by use of a straddle crane.

15. An inline terminal, hub and distribution system, including:
a terminal including a substantially contiguous plot of land having a roadway with an entrance and an exit, a plurality of train rails and a distribution warehouse in proximity to the train rails;
the distribution warehouse including an inbound dock for facilitating emptying and distributing of cargo and an outbound dock, wherein the distribution warehouse is adapted to allow ease of movement of cargo between the inbound and outbound docks and provide temporary storage of the cargo;
a crane for carrying a container from a railroad car to a track side location or visa versa; and
at least one tractor truck for trucking the container from the track side location to or from an inbound or outbound loading dock or visa versa and the at least one tractor truck for trucking the container from the outbound loading dock to a desired location away from the terminal.

16. The system of claim 15 wherein the entrance to the terminal includes a roadway strategically designed to direct the tractor trucks to begin at a substantially centrally located position for defining a desired traffic flow in and around the terminal.

17. The system of claim 15 wherein the distribution warehouse includes means for sorting the cargo of a container, including at least one of:
means for inspecting the cargo;
means for inventorying the inbound container; and
means for documenting the results of the inspection and inventory.

18. The system of claim 15 wherein the terminal and distribution warehouse define a strip mall complex comprising at least one of offices, temporary container storage, roadways, shops, track rails and parking, to improve efficiency in transporting containers and terminal logistics.

19. The system of claim 15 wherein the terminal is adapted to accommodate a plurality of cranes, tractor trailers, roadways and movement of containers independently and in an integrated fashion, to provide a steady flow of containers in and out of the terminal.

20. The system of claim 15 wherein the substantially contiguous plot comprises a generally rectangular plot of land substantially parallel to the track rails and the terminal and distribution warehouse, define a strip mall complex including offices, shops, track rails, roadways and parking configured for efficient traffic, rail and pedestrian management.
